(19) United States
(12) Patent Application Publication
(10) Pub. No.: US 2009/0132523 A1
(43) Pub. Date: May 21, 2009

(54) INFORMATION PROCESSING APPARATUS, CONTROL METHOD THEREOF, COMPUTER PROGRAM, AND STORAGE MEDIUM

(75) Inventor: Hidenori Ishiwata, Kawasaki-shi (JP)

Correspondence Address: COWAN LIEBOWITZ & LATMAN P.C.;JOHN J TORRENTE, 1133 AVE OF THE AMERICAS, NEW YORK, NY, 10036, US

(73) Assignee: CANON KABUSHIKI KAISHA, Tokyo (JP)

(21) Appl. No.: 12/252,787

(22) Filed: Oct. 16, 2008

(30) Foreign Application Priority Data
Nov. 16, 2007 (JP) 2007-298592

(51) Int. Cl. G06F 17/30; G06F 7/06

(52) U.S. Cl. 707/5; 707/E17.137

(57) ABSTRACT

An information processing apparatus includes: an acceptance unit adapted to accept a selection of a plurality of data for generating a search condition; a readout unit adapted to read out, for each piece of the plurality of data, metadata showing attribute values of the piece of data, from a storage device; a generation unit adapted to analyze, for each type of attribute, the attribute values shown by the metadata of the plurality of data, and generate a search condition candidate that includes an attribute value representative of the attribute values of the plurality of data; a presentation unit adapted to selectably present the search condition candidate generated by the generation unit to a user; and a search unit adapted to retrieve, from a plurality of search target data, data that matches a search condition candidate selected by the user.

### BACKGROUND OF THE INVENTION

1. Field of the Invention

The present invention relates to an information processing apparatus, a control method thereof, a computer program, and a storage medium, and in particular to a technique for retrieving data.

2. Description of the Related Art

In terms of configurations for collecting data having common information, a search folder function is conventionally known that collects data with a keyword, an attribute value or the like designated by a user as a key, with regard to data having attribute information assigned thereto. A search folder function is a function that displays a set of data retrieved from a search based on a designated key, as though the data were stored in a single folder. The folder storing data from a search result is called a search folder. In terms of exemplary search folder functions, the MacOS X smart folder and the Windows® Vista search folder, for example, are known.

Using a search folder function, a user is able to locate desired data within a search folder without having to think about where in the PC's folder hierarchy the data is stored by setting a keyword or attribute information such as a date as a condition. Another known configuration involves adding identification information (ID, etc.) unique to registered data to the search conditions when a user directly registers data that he or she wants to collect in a search folder rather than registering a search condition (e.g., see Japanese Patent Application Laid-Open No. 2004-038755).

However, with conventional configurations for collecting data, the user is heavily involved since he or she has to set the conditions for collecting data. Also, creating suitable conditions for collecting the exact right desired data group is not easy, and demands skill and experience on the part of the user.

### SUMMARY OF THE INVENTION

The present invention has been made in consideration of the above problems, and has as its object to provide a data retrieval technique that enables a user to easily set search conditions.

According to one aspect of the present invention, an information processing apparatus includes:

an acceptance unit adapted to accept a selection of a plurality of data for generating a search condition;

a readout unit adapted to read out, for each piece of the plurality of data, metadata showing attribute values of the piece of data, from a storage device;

a generation unit adapted to analyze, for each type of attribute, the attribute values shown by the metadata of the plurality of data, and generate a search condition candidate that includes an attribute value representative of the attribute values of the plurality of data;

a presentation unit adapted to selectably present the search condition candidate generated by the generation unit to a user; and

a search unit adapted to retrieve, from a plurality of search target data, data that matches a search condition candidate selected by the user.

According to another aspect of the present invention, a control method of an information processing apparatus, includes the steps of:

accepting a selection of a plurality of data for generating a search condition;

reading out, for each piece of the plurality of data, metadata showing attribute values of the piece of data, from a storage device;

analyzing, for each type of attribute, the attribute values shown by the metadata of the plurality of data, and generating a search condition candidate that includes an attribute value representative of the attribute values of the plurality of data;

selectably presenting the search condition candidate generated in the generation step to a user; and

retrieving, from a plurality of search target data, data that matches a search condition candidate selected by the user.

Further features of the present invention will become apparent from the following description of exemplary embodiments (with reference to the attached drawings).

### BRIEF DESCRIPTION OF THE DRAWINGS

FIG. 1 shows a functional arrangement of a data collection apparatus.

FIG. 2 is a block diagram showing the hardware configuration of the data collection apparatus.

FIG. 3 shows an exemplary collection target data table.

FIG. 4 shows an exemplary collection target data attribute trend table.

FIG. 5 shows an exemplary complete registered data number table.

FIG. 6 shows an exemplary data collection condition candidate table.

FIG. 7 shows an exemplary data collection condition table.

FIG. 8 shows the flow of a process performed when selecting collection target data.

FIG. 9 shows the flow of a process of reflecting the content of collection target data in the collection target data attribute trend table.

FIG. 10 shows data collection condition candidates presented to a user.

FIG. 11 shows a process of changing data collection condition candidates.

FIG. 12 shows a process of changing data collection condition candidates.

FIG. 13 shows a process of changing data collection condition candidates.

FIG. 14 shows a process of changing data collection condition candidates.

FIG. 15 shows an exemplary stored data number threshold table.

FIG. 16 shows exemplary collection target data.

FIG. 17 shows the flow of a process of presenting data collection condition candidates.

### DESCRIPTION OF THE EMBODIMENTS

Embodiments according to the present invention will now be described in detail with reference to the accompanying drawings. The constituent elements shown in the embodiments are, however, merely illustrative, and are not intended to limit the scope of the present invention. Further, not all combinations of features described in the embodiments are essential to the means by which the present invention solves the above problems.

### Embodiment 1

In the present embodiment, a configuration for automatically generating a search folder will be described as an exemplary data collection apparatus in a file system. In the present embodiment, the user, when generating a search folder, selects a group of data that he or she wants to collect, rather than setting search conditions. In response, the data collection apparatus presents suitable search condition candidates to the user. Once the user has selected a search condition candidate, the data collection apparatus then automatically generates a search folder that includes the desired data group. Accordingly, the user is able to easily set search conditions since he or she is not required to set the search conditions manually.

Functional Arrangement

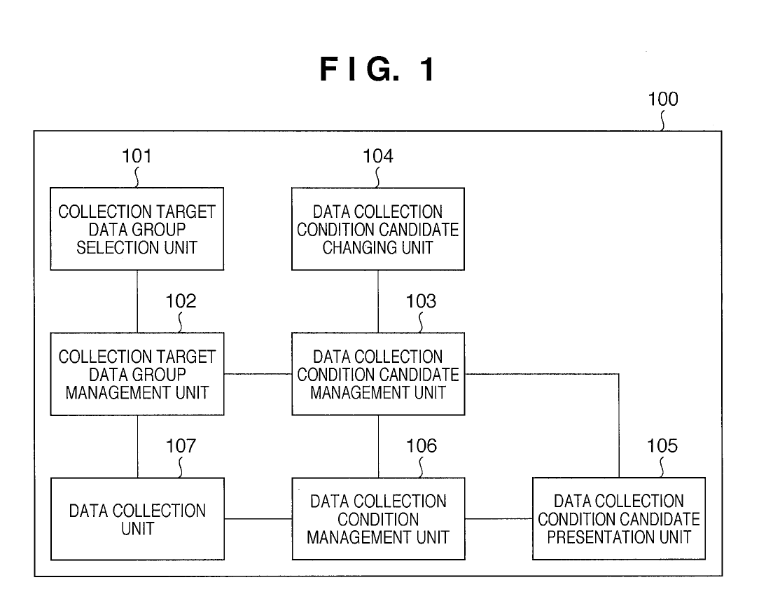

FIG. 1 shows a functional arrangement of a data collection apparatus 100 according to the present embodiment. Reference numeral 101 denotes a collection target data group selection unit that selects a group of data such as content that is to form a collection target (search target), from data saved in a file system. The collection target data group selection unit 101 performs an acceptance process of accepting a user selection of data that he or she wants to collect in a search folder, that is, a user selection of a plurality of data for generating a search condition.

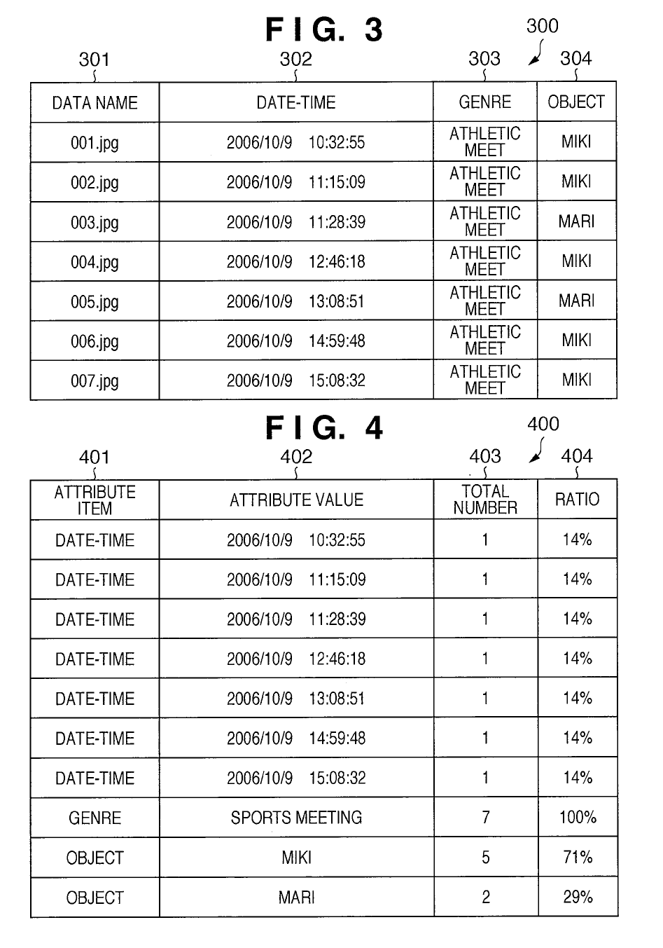

Reference numeral 102 denotes a collection target data group management unit that manages the data selected by the collection target data group selection unit 101, using a collection target data table 300. FIG. 3 shows an exemplary collection target data table 300 managed by the collection target data group management unit 102. In FIG. 3, photographic data is targeted for management. The first line shows the items of attribute information attached to the data, namely, data name 301, date-time 302, genre 303 and object 304, while the second line down shows the individual attribute values of the attribute information 301 to 304. The collection target data group management unit 102 uses the table 300 to manage data targeted for collection.

Note that the attribute values of each piece of the data are described in metadata corresponding to that data. Once data for generating a search condition has been selected by the user, the data collection apparatus 100 then performs a process (readout process) of reading out the metadata corresponding to the selected data from a storage device such as a RAM 202 or an external storage device 206 (described below).

Here, in the present embodiment, the case will be described where data and corresponding metadata are realized as the same file. In this case, once a photographic data file has been selected by the user, data defining the actual image and metadata showing the attributes of the data (e.g., data name, date-time, genre, object) are selected at the same time. Thus, in the present embodiment, if a file that includes data and metadata is selected, the data collection apparatus 100 reads out the portion in the selected file equivalent to the metadata from the storage device.

Note that data and metadata may, needless to say, be realized as separate files. Also, a plurality of data and a plurality of metadata may be realized as a single file. Further, at least one of one or more pieces of data and one or more pieces of metadata may be realized as a single file.

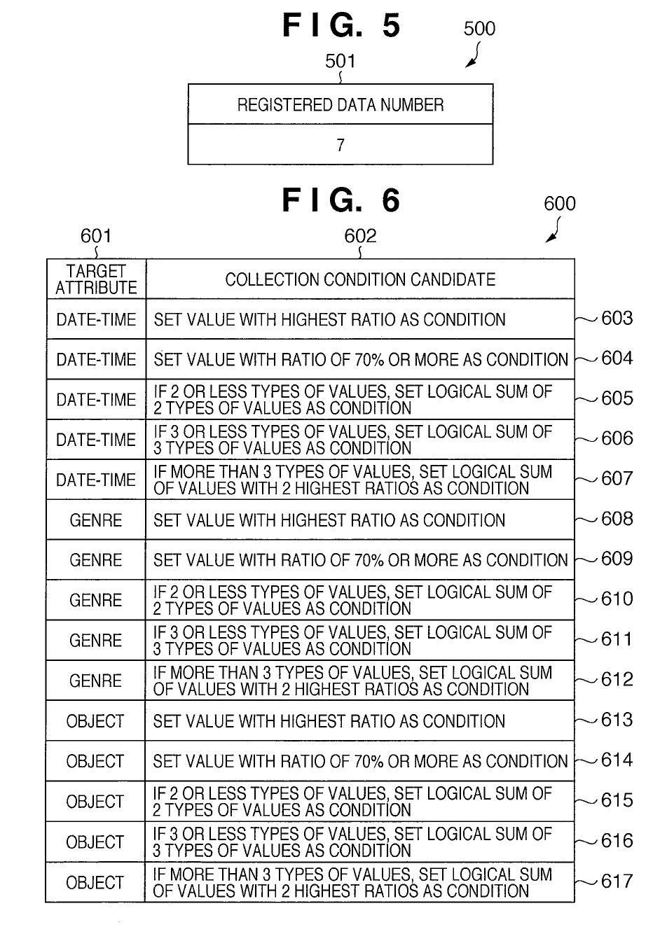

FIG. 4 shows an exemplary collection target data attribute trend table 400 in which the trends for each attribute item are compiled from the collection target data table 300. The first line shows attribute item 401, attribute value 402, total number 403 and ratio 404, while the second line shows specific data values for each attribute item. The total number 403 is the number of data whose corresponding attribute item 401 has the same attribute value 402, while the ratio 404 shows the percentage of the complete number of registered data occupied by the total number 403. The complete number of registered data is managed as a complete registered data number table 500 as shown in FIG. 5. 0 is stored as the initial value in the complete registered data number table. Note that tables such as the collection target data table 300, the collection target data attribute trend table 400 and the complete registered data number table 500 are generated and managed for each search folder.

Reference numeral 103 denotes a data collection condition candidate management unit that manages condition candidates for performing data collection. FIG. 6 shows an exemplary data collection condition candidate table 600 that is managed by the data collection condition candidate management unit 103. The data collection condition candidate management unit generates a number of condition candidates (search condition candidates) in advance, and manages the generated condition candidates in the data collection condition candidate table 600. The first line shows target attribute 601 and collection condition candidate 602, while the second line down shows specific values for the target attributes and the candidate conditions. The data collection condition candidate management unit 103 holds (stores) the data collection condition candidates in a generic form such as in the table 600, rather than in a form where the data collection condition candidates are expressed in specific attribute values.

As will be described below, the data collection apparatus 100 generates specific collection condition candidates to present to the user, based on the collection condition (search condition) candidates in generic form in the table 600, and presents the specific collection condition candidates to the user. Consequently, it can be said that the generic collection conditions in the table 600 define rules for generating (candidates for) search conditions.

The rules of the collection condition candidates illustrated in the table 600 of FIG. 6 can be sorted into the following three groups.

Rules according to which a collection condition that includes an attribute value having the highest ratio, out of the attribute values of the data, is generated as a collection condition candidate (603, 608, 613).

Rules according to which a collection condition that includes an attribute value having a ratio greater than or equal to a prescribed value, out of the attribute values of the data, is generated as a collection condition candidate (604, 609, 614).

Rules according to which a collection condition that includes a logical sum of a prescribed number of attribute values selected in descending order of ratio, out of the attribute values of the data, are generated as a collection condition candidate (605-607, 610-612, 615-617).

Such rules enable a search condition candidate that includes an attribute value representative of the attribute values of the data to be generated.

Note that the data collection condition candidate table 600 is merely by way of example. It is also possible to manage only collection condition candidate 602 as a table, without specifying target attribute 601. Values such “ratio of 70%” and “2 types” in 604 and 605 are given as examples and are not limiting. Conditions not described in the table may be included as candidates, and at least one of the groups of candidates corresponding to the above three classifications need not be provided.

Reference numeral 104 denotes a data collection condition candidate changing unit for making changes to the data collection condition candidates managed by the data collection condition candidate management unit 103. Changes made to the data collection condition candidates are reflected in the data collection condition candidate table 600, in response to the user editing collection conditions that he or she wants to add, or delete.

Reference numeral 105 denotes a data collection condition candidate presentation unit. The data collection condition candidate presentation unit 105 converts generic data collection condition candidates managed in the data collection condition candidate table 600 to specific attribute values based on the collection target data attribute trend table 400, and presents the specific attribute values to the user.

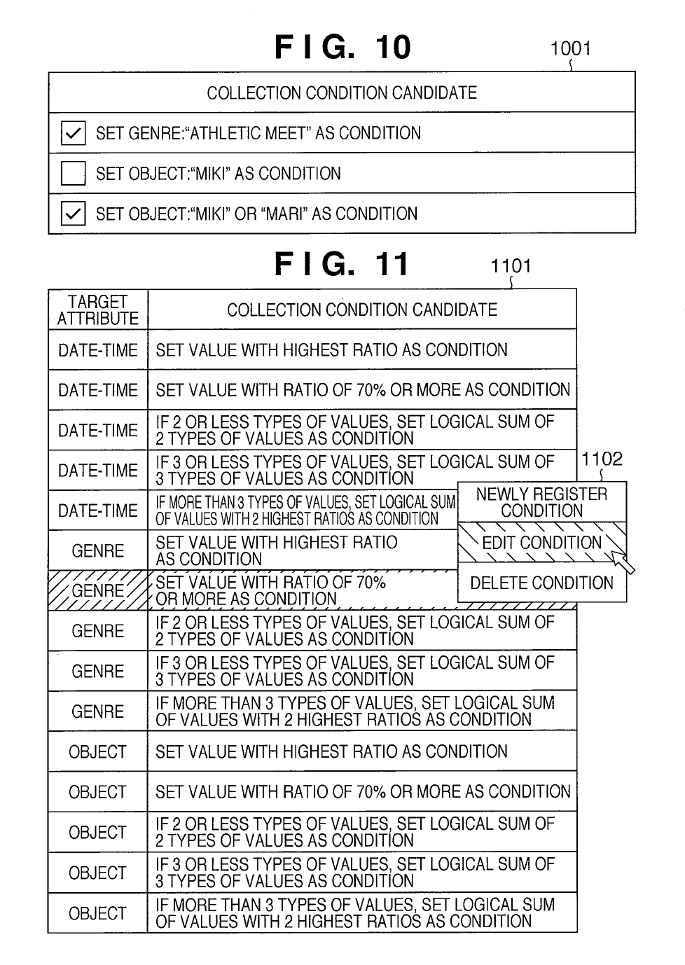

Note that the data collection condition candidate presentation unit 105 analyses the attribute values of the data for each type of attribute, and selectably presents an attribute value representative of the attribute values of the data to the user as a search condition candidate. In other words, search condition candidates presented to the user are representative of the qualities of the data for generating search conditions selected by the user. Consequently, the user is able to easily set search conditions without needing to perform complex operations, by selecting data having qualities equivalent to the data that he or she wants to retrieve. FIG. 10 shows an exemplary collection condition candidate presentation screen presented to the user. The user selects conditions that he or she wants to set from the data collection condition candidates presented on the screen.

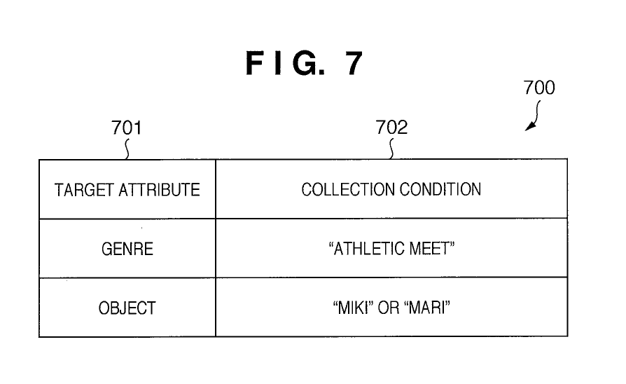

Reference numeral 106 denotes a data collection condition management unit that manages collection conditions selected by the user from the data collection condition candidates presented by the data collection condition candidate presentation unit 105. FIG. 7 shows an exemplary data collection condition table 700 managed by the data collection condition management unit 106. The data collection condition management unit 106 also holds data collection conditions in an expressive form using specific attribute values, similarly to the data collection condition candidate presentation unit 105. The first line shows target attribute 701 and collection condition 702, while the second line down shows specific values for the target attributes and collection conditions.

Reference numeral 107 denotes a data collection unit that, in accordance with the data collection conditions (search conditions) managed by the data collection condition management unit 106, collects (retrieves) data matching the collection conditions. If “athletic meet” for genre and “Miki” or “Mari” for object, for example, are set in the data collection condition table 700 as collection conditions, data collection is performed based on these conditions. Unselected data that fits the conditions in the data collection condition table 700 is automatically collected in the search folder in addition to the data selected by the collection target data group selection unit 101. Retrieved data is also added to the collection target data table 300 in FIG. 3 at this time.

Hardware Configuration

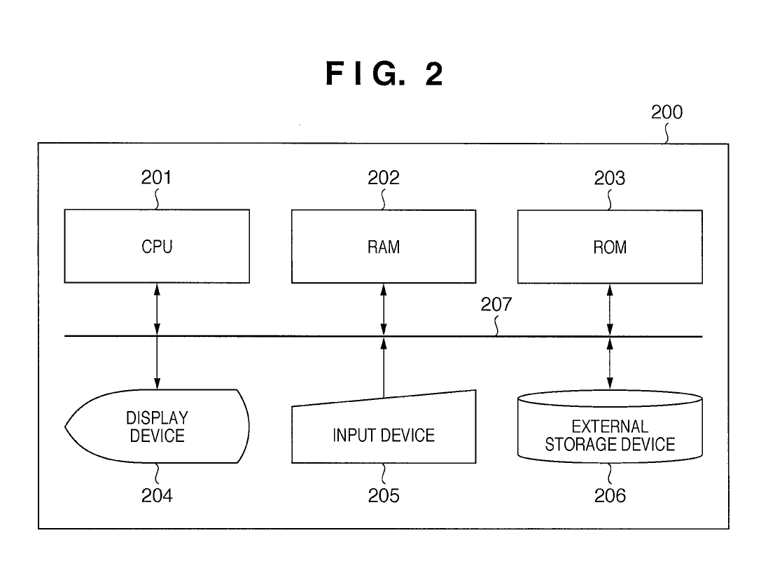

FIG. 2 is a block diagram showing the hardware configuration of a computer apparatus 200 serving as the data collection apparatus 100 according to the present embodiment. In the present embodiment, the computer apparatus 200 is realized by a personal computer (PC), which constitutes one type of information processing apparatus. The computer apparatus 200 may, however, be realized by an arbitrary information processing apparatus such as a work station (WS) or a personal digital assistant (PDA) depending on the application and purpose.

In FIG. 2, reference numeral 201 denotes a central processing unit (CPU) that performs overall control of the computer apparatus 200. Reference numeral 202 denotes a random access memory (RAM) that temporarily stores computer programs and data supplied from an external device or the like. Reference numeral 203 denotes a read-only memory (ROM) that stores control programs and parameters that do not require changing.

Reference numeral 204 denotes a display device that realizes display of condition candidates in the data collection condition candidate presentation unit 105, and the like. The display device 204 is realized by a liquid crystal display, a cathode ray tube (CRT) monitor, an organic electroluminescent (EL) display, or a surface-conduction electron-emitter display (SED), for example. Reference numeral 205 denotes an input device that realizes data selection in the collection target data group selection unit 101 and changing of data collection condition candidates in the data collection condition candidate changing unit 104. The input device 205 is realized by a keyboard or a pointing device, for example.

Reference numeral 206 denotes an external storage device that realizes data storage in the collection target data group management unit 102, the data collection condition candidate management unit 103, and the data collection condition management unit 106. The external storage device 206 is realized by a hard disk (HD), for example. Reference numeral 207 denotes a system bus that communicably connects the respective units 201 to 206.

Basic Processing

A computer program for realizing the data collection apparatus 100 of the present embodiment will now be described. Where not particularly specified, the processing of the steps described below is executed as a result of the CPU 201 controlling the data collection apparatus 100 (computer apparatus 200) based on the program.

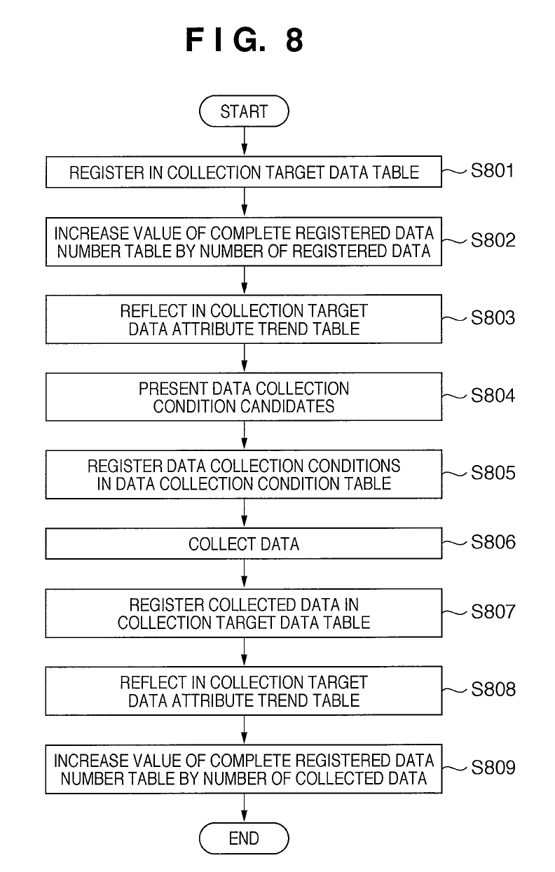

FIG. 8 is a flowchart showing an overview of a process (basic processing) executed by the data collection apparatus 100, when the user has selected collection target data as a target for generating a search folder, in the present embodiment. Hereinafter, the case where the user selects the data shown in FIG. 16 as collection target data 1600 will be described as an example.

In FIG. 8, firstly the seven pieces of selected data in FIG. 16 are registered in the collection target data table 300 shown in FIG. 3 (S801). Note that, as aforementioned, the data collection apparatus 100 acquires attribute values in response to data being registered, by reading out metadata corresponding to the data from a storage device.

Next, the value of the complete registered data number table 500 shown in FIG. 5 is increased by the number of registered data, seven (S802), and the attribute information assigned to the data is analyzed and reflected in the collection target data attribute trend table 400 shown in FIG. 4 (S803). This analysis will be described in detail below.

Data collection condition candidates are presented to the user based on the collection target data attribute trend table 400 and the data collection condition candidate table 600 (S804). The method of presenting data collection condition candidates will be described below. As aforementioned, the data collection condition candidate table 600 contains only data collection conditions using generic expressions to define rules for deriving specific search conditions. The data collection apparatus 100 thus performs presentation after generating specific data collection condition (search condition) candidates based on the generically expressed data collection conditions. Specific data collection condition candidates are generated using both the rules for deriving specific search conditions defined by the generically expressed data collection conditions and the specific values in the collection target data attribute trend table.

FIG. 10 shows an exemplary screen on which collection condition candidates are selectably presented to the user. The user selects desired conditions from the presented condition candidates using an input device 205 such as a pointing device.

Next, in response to the user selecting conditions, the data collection conditions selected by the user are registered in the data collection condition table 700 shown in FIG. 7 (S805). Data other than the seven pieces of data in FIG. 16 that fits (matches) the conditions is collected based on the data collection conditions registered at S805 (S806).

Next, the collected data is registered in the collection target data table (S807). The attribute information of the data registered at S807 is then reflected in the collection target data attribute trend table (S808). Further, the value in the complete registered data number table 500 is increased by the number of data registered at S807 (S809). The data collection method of the present embodiment also accommodates update processing such as adding data to a search folder that has already been created, with the processing of S807 to S809 being for this purpose.

The above series of processes enables search conditions to be easily set based on the seven pieces of data selected when generating the search folder. Further, this processing enables missed data that was not selected when generating the search folder despite fitting the selected conditions to be collected in the search folder.

Attribute Value Analysis

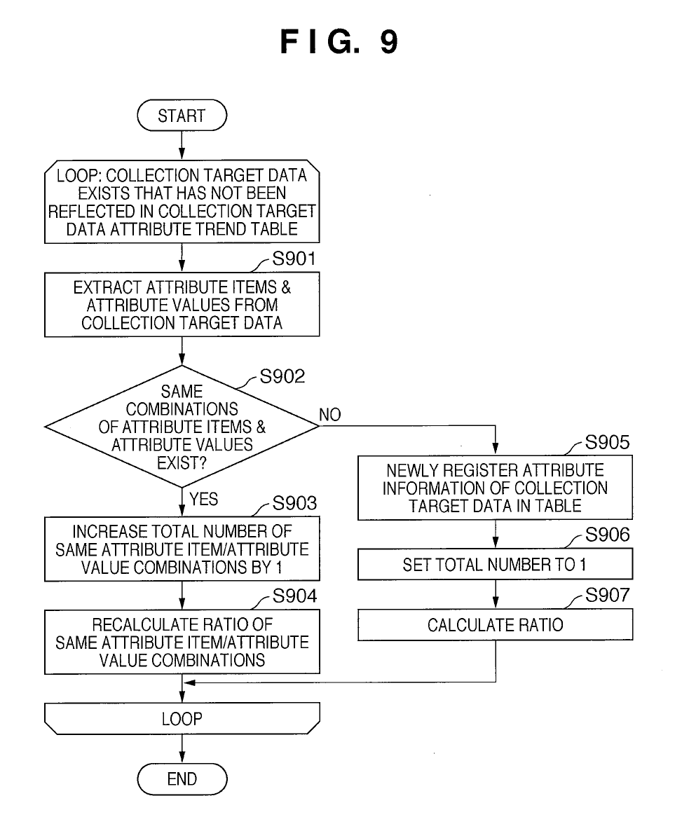

FIG. 9 is a flowchart showing in detail a process (attribute value analysis) performed in S803 and S808 when attribute values are analyzed and the content of the collection target data is reflected in the collection target data attribute trend table. The processing of S901 to S907 is executed once for each attribute item of the collection target data registered in the collection target data table.

Consider the case where the data in FIG. 16 is registered. Firstly, attribute items and attribute values are extracted from the portion equivalent to the metadata in the file “001.jpg”, which constitutes the first piece of collection target data (S901). In this example, date “2006/10/9 10:32:55”, genre “athletic meet”, and object “Miki” are extracted.

Next, it is determined whether the combinations of extracted attribute items and attribute values already exist in the collection target data attribute trend table (S902). If they exist (S902: YES), the processing proceeds to S903, and if they do not exist (S902: NO), the processing proceeds to S905. In the above example, the combinations of extracted attribute items and attribute values do not exist, so the processing proceeds to S905.

At S905, the attribute information of the collection target data is newly registered in the collection target data attribute trend table. After setting the respective total numbers (501), in the complete registered data number table 500 exemplified in FIG. 5, to 1 (S906), the respective ratios (404) are calculated (S907).

Next, the attribute items and attribute values are extracted from the second piece of collection target data, “002.jpg” (S901). That is, date “2006/10/9 11:15:09”, genre “athletic meet”, and object “Miki” are extracted.

It is then determined whether the combinations of extracted attribute items and attribute values already exist in the collection target data attribute trend table (S902). The extracted attribute item/attribute value combination of date “2006/10/9 11:15:09” does not exist in the collection target data attribute trend table, so this combination is newly registered (S905). On the other hand, the extracted attribute item/attribute value combinations of genre “athletic meet” and object “Miki” already exist. Thus, the total numbers for genre “athletic meet” and object “Miki” having the same attribute item and attribute value are increased by 1 (S903), and the ratios are recalculated using the increased total numbers (S904). All of the collection target data is similarly registered in the collection target data attribute trend table.

Condition Candidate Display

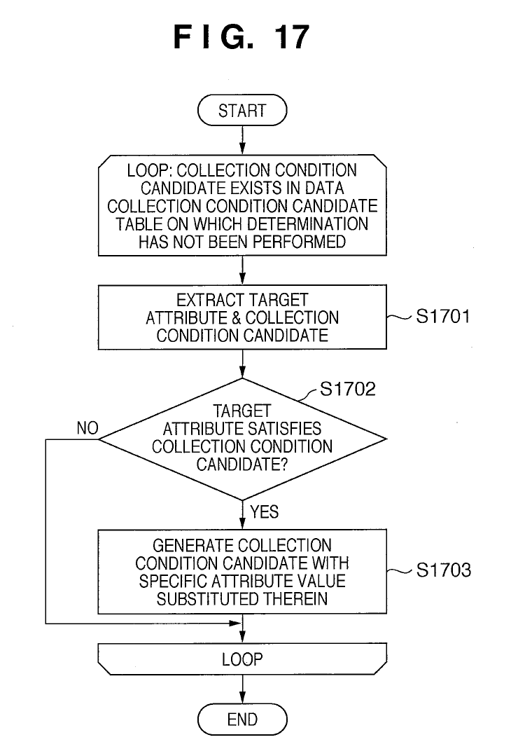

FIG. 17 is a flowchart showing a process (condition candidate display) performed when generating a data collection condition candidate (search condition candidate) that include an attribute value representative of the attribute values of the data, and presenting the data collection condition candidate. Here, the case where a data collection condition candidate is presented to the user based on the collection target data attribute trend table 400 and the data collection condition candidate table 600 will be described as an example.

Firstly, collection condition candidates are extracted from the data collection condition candidate table 600 for each type of target attribute (S1701). Hereinafter, the case shown in the data collection condition candidate table 600 of FIG. 6 will be described as an example.

Next, it is determined whether the rules for generating a search condition shown by the extracted collection condition candidates match any of the attribute trends described in the attribute trend table (FIG. 4) in which collection target data attribute trends were reflected at S803 of FIG. 8 (S1702). In the FIG. 6 example, it is determined whether the target attribute “date-time”, satisfies “set value with highest ratio as condition” (603) constituting the first condition candidate. The collection target data attribute trend table 400 shows that the ratios for date-time are all 14%, so an attribute value with the highest ratio cannot be extracted. Therefore, it is determined not to present 603 as a collection condition candidate, since the rule of this collection condition candidate does not match any of the attribute trends (S1702: NO), and if there is a collection condition candidate on which the determination has not been performed, the processing returns to S1701, and the next target attribute and collection condition candidate are extracted. It is similarly determined not to present 604 to 607, since they are also not suitable as collection condition candidates.

On the other hand, with the condition candidate “set value with highest ratio as condition” (608) for genre, “athletic meet” has the highest ratio at 100%, so the rule of this condition candidate matches an attribute trend. Thus, it is determined to present this attribute value to the user as a condition candidate (S1702: YES), and the processing proceeds to S1703.

At step S1703, a collection condition candidate is generated by substituting a specific value for the attribute value. For example, with the condition candidate “set value with highest ratio as condition” (608) for genre, the collection condition candidate, genre: “athletic meet”, is generated.

The determination of S1702 is performed for all of the data collection condition candidates, and condition candidates to be presented to the user are generated. Note that in the FIG. 4 example, the condition candidates 608 and 609 result in the same candidate (genre: “athletic meet”). If the same condition candidate is thus generated a plurality of times, the condition candidate is presented to the user only once.

The collection condition candidates shown in FIG. 10 are generated and presented to the user as a result of this process, based on the FIG. 4 example. In FIG. 10, genre: “athletic meet”, object: “Miki”, and object: “Miki” or “Mari”, are provided as condition candidates, from which the user has selected genre: “athletic meet” and object: “Miki” or “Mari”.

Next, the process of changing (the rules for) generic collection condition candidates defined in the data collection condition candidate table 600 according to an instruction from the user will be described.

FIGS. 11 to 14 show exemplary screens when making a change to the data collection condition candidates in the data collection condition candidate changing unit 104. FIG. 11 shows an exemplary screen for accepting a selection of a collection condition candidate to be changed. The data collection apparatus 100, on accepting a selection of a collection condition candidate on a collection condition candidate screen 1101 in FIG. 11, displays a menu 1102 for accepting a selection of an operation on the selected collection condition candidate. Hereinafter, a case will be described where the menu 1102 for accepting an operation selection is displayed with the target attribute “genre” and the collection condition candidate “set value with ratio of 70% or more as condition” having been selected by the user as the condition that he or she want to edit, and “edit condition” for making a change to the collection condition candidate has been selected.

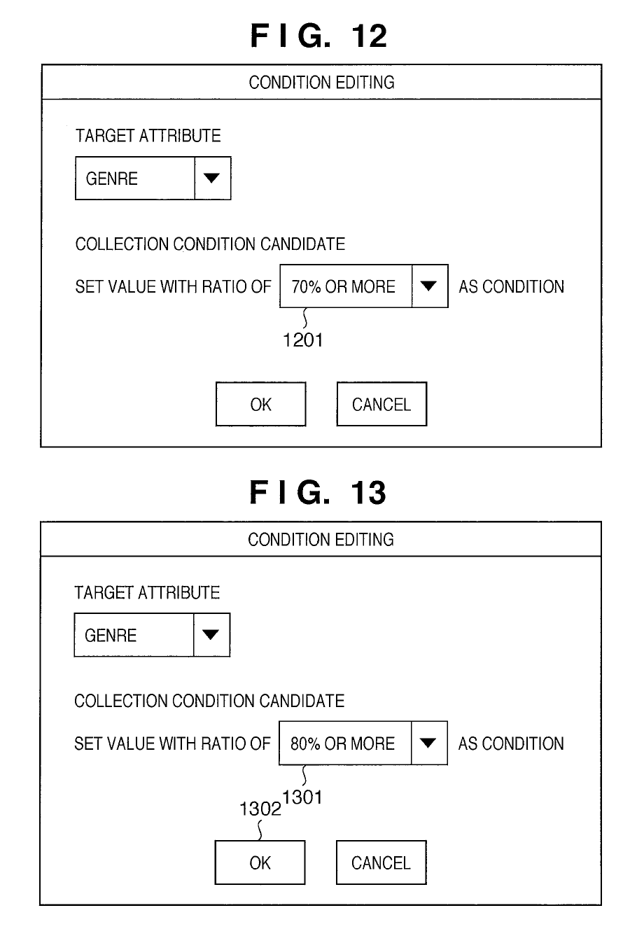

When “edit condition” is selected, the data collection apparatus 100 displays a condition editing screen for accepting editing of the collection condition candidate. FIG. 12 shows an exemplary condition editing screen. The current collection condition is displayed on the exemplary condition editing screen shown in FIG. 12. Here, an operation in the case of changing the ratio of the collection condition candidate at which the attribute value of the target attribute “genre” is set as a search condition will be described as an example. In this case, the user selects a pull-down menu 1201.

If the user wants to set “set value with ratio of 80% or more as condition” as a condition candidate he or she scrolls down and selects “80%” from the pull-down menu as shown in FIG. 13 (1301). FIG. 13 shows the exemplary condition editing screen with the pull-down menu selected. The user presses an OK button 1302 when setting is completed.

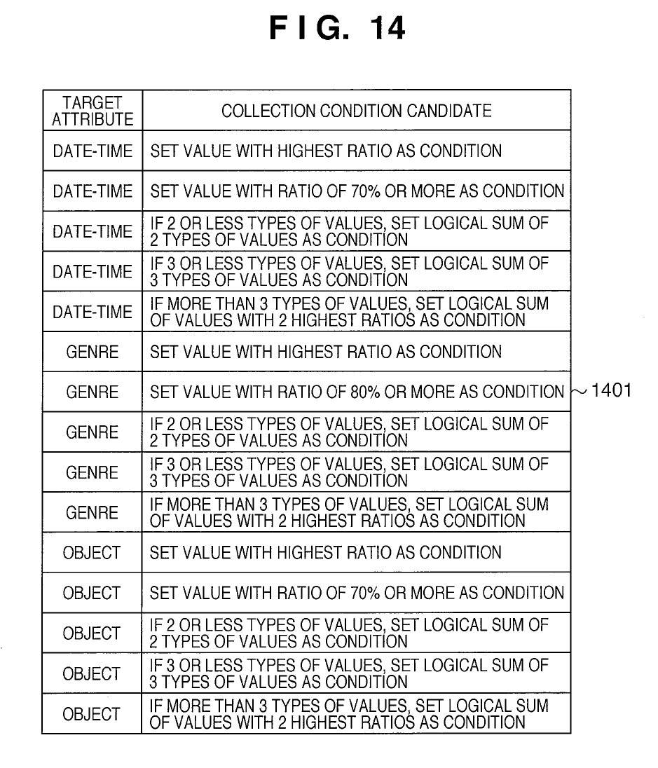

This process enables the collection condition candidate to be changed as shown in FIG. 14. FIG. 14 shows the changed collection condition candidate.

Note that this setting method is merely by way of example, and that the method of changing a generic collection condition candidate can, needless to say, be realized by various configurations, such as by entering a condition using arbitrary text, rather than in pull-down form.

As described above, the configuration according to the present embodiment analyzes the attribute values of a plurality of data selected by a user, and automatically presents search conditions that include attribute values representative of the attribute values of the data as candidates. The user is thus able to easily set a search condition simply by performing an operation to select a search condition from the presented search conditions.

Also, since search condition candidates are generated based on rules for generating search conditions stored in a storage device, the user is able to ensure that the data collection apparatus 100 presents useful attribute values as search condition candidates by changing the rules.

### Embodiment 2

In Embodiment 1, an exemplary basic configuration for automatically generating and presenting search condition candidates was described, although the object of the present invention can be realized even when various changes are made to the above configuration. The basic configuration of a second embodiment for implementing the present invention is the same as that of Embodiment 1.

For example, a folder for storing collection target data may provided in advance, and data stored in this folder may be registered as collection target data at S801 of FIG. 8. In other words, data stored in a prescribed folder may be accepted as data selected by a user for generating search conditions. Such a configuration facilitates operation since the user is able to select collection target data simply by performing an operation to store data in this folder.

In Embodiment 1, data collection condition candidates are generated and presented in response to the user designating a group of data as a collection target, although the present invention is not limited to this. For example, the data collection apparatus may periodically monitor a data group designated by the user, and generate and present data collection condition in response to the number of data in the group exceeding a predetermined value. Specifically, in the case where, for example, a folder for storing collection target data is provided in advance as described above, search conditions can be generated in response to the number of data stored in the folder exceeding a predetermined value. Alternatively, when the number of stored data exceeds a stored data number preset by the user or the data collection apparatus for each well-defined set such as a folder, the fact that the set has been converted to a search folder can be presented to the user together with the collection conditions.

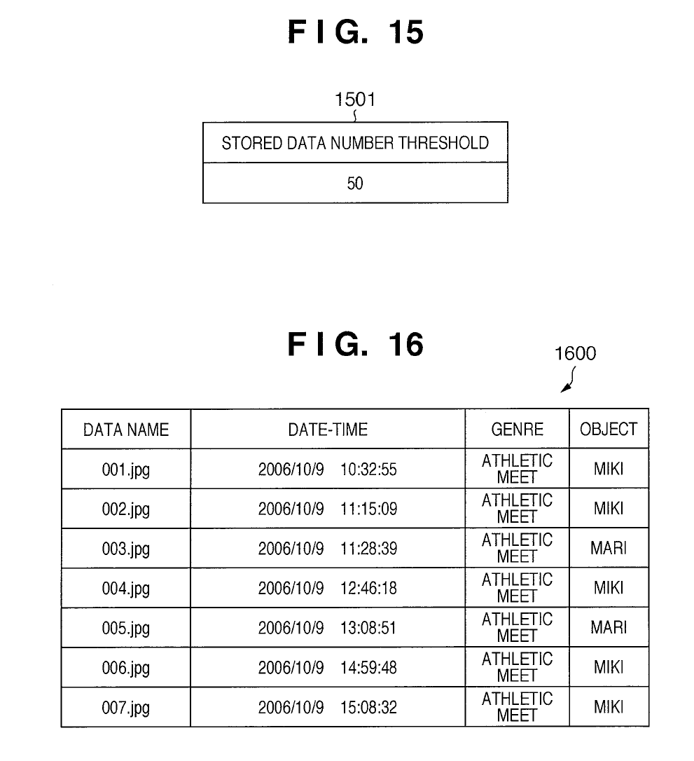

FIG. 15 shows an exemplary stored data number threshold table. Reference numeral 1501 denotes the threshold of the stored data number. At the point at which stored data exceeds this value, a condition determination similar to Embodiment 1 can be performed, and if any of the target attributes satisfy the condition candidates, the fact that the set has been converted to a search folder can be presented to the user together with the collection conditions.

Thus, by executing the conversion to a search folder automatically using a stored data number, a situation where the user forgets to perform the conversion can be prevented, and a data set without omissions can be generated. Note that rather than targeting individual folders for monitoring, a plurality of folders or all of the folders can be targeted for monitoring. Search conditions may also be generated in response to a predetermined time period elapsing after data is stored in the folder.

If, when setting data collection condition, a search folder with those conditions already exists, this fact may be notified to the user. Alternatively, if, when setting data collection condition, it is determined whether a search folder with a similar data configuration already exists after matching data has been collected, and a similar search folder does exist, this fact may be notified to the user. Such configurations enable repetition of redundant operations to be prevented.

When presenting search condition candidates to the user, the generic conditions shown in FIG. 6 may be presented as data collection conditions, rather than the specific values in the collection condition candidate table shown in FIG. 10. Such a configuration enables the user to select more suitable search conditions.

Note that with a conventional configuration, when arbitrary data is registered in a search folder that already exists or when arbitrary data is deleted from a search folder, identification information or the like unique to the registered data is added to the conditions. In contrast, search conditions that fit all of the data in the search folder that includes the registered data may be regenerated dynamically. That is, search condition candidates may be updated in response to at least one of a user operation to add data to and a user operation to delete data from data obtained as a search result. The regenerated conditions are presented to the user similarly to Embodiment 1, and the user makes a selection. A configuration such as this enables the user to perform data collect with more desirable conditions by performing an operation on the search folder.

In the present embodiment, the case where the collection target data is photographic data was described, although other data may be targeted for collection. Examples include music files, moving image files, and document files. Apart from a PC, the present configuration can also be mounted in a device such as a music player or a copier.

It is also possible to perform a search using data collection conditions only once, rather than performing continuous data collection. This configuration enables the user to perform data collection only when necessary.

### Additional Embodiments

The object of the present invention is, needless to say, also achieved by executing the program code of software for realizing the functions of the foregoing embodiments in a system or apparatus. In this case, the program code itself realizes the functions of the foregoing embodiments, and this program code is included within the technical scope of the present invention.

The program code can be supplied to the system or apparatus by being recorded to a computer-readable storage medium, for example. A computer (or CPU or MPU) in the system or apparatus can also achieve the object of the present invention by reading out and executing the program code stored in the storage medium. Accordingly, the storage medium storing this program code is also included within the technical scope of the present invention.

Storage media that can be used for supplying the program code include, for example, flexible disk, hard disk, optical disk, magneto-optical disk, CD-ROM, CD-R, magnetic tape, nonvolatile memory card, ROM, and DVD.

Moreover, the program code need not be provided with all of the elements for realizing the functions of the foregoing embodiments as a result of a computer reading out and executing the program code. That is, program code that achieves the object in coordination with at least one of software or hardware incorporated in a computer is also included.

For example, in the case where an OS or the like running on a computer performs part or all of the actual processing based on instructions in program code, and the functions of the foregoing embodiments are realized as a result of this processing, this program code is also included within the technical scope of the present invention. Incidentally, OS stands for operating system.

Alternatively, a CPU or the like provided in a function expansion board or a function expansion unit inserted in or connected to a computer may, for example, perform part or all of the actual processing based on instructions in program code, with the functions of the foregoing embodiments being realized as a result of this processing. The program code in such a case is also included within the technical scope of the present invention. Note that the function expansion board or the function expansion unit is able to perform such processing by reading the program code to a memory provided therein and executing the read program code.

According to the above configurations, selected data is analyzed and candidate conditions for collecting data are presented to the user, in response to the user selecting data to be targeted for collection. The user's workload in the condition setting process can thereby be reduced. By using the presented conditions, it is possible for anyone to easily collect a data group with few omissions and little noise from a target data group.

According to the present invention, a data retrieval technique can be provided that enables the user to easily set search conditions.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-298592, filed Nov. 16, 2007, which is hereby incorporated by reference herein in its entirety.

What is claimed is:

1. An information processing apparatus comprising:
an acceptance unit adapted to accept a selection of a plurality of data for generating a search condition;
a readout unit adapted to read out, for each piece of the plurality of data, metadata showing attribute values of the piece of data, from a storage device;
a generation unit adapted to analyze, for each type of attribute, the attribute values shown by the metadata of the plurality of data, and generate a search condition candidate that includes an attribute value representative of the attribute values of the plurality of data;
a presentation unit adapted to selectably present the search condition candidate generated by the generation unit to a user; and
a search unit adapted to retrieve, from a plurality of search target data, data that matches a search condition candidate selected by the user.

2. The information processing apparatus according to claim 1, further comprising a storage unit adapted to store a rule for generating the search condition, wherein
the generation unit generates the search condition candidate based on the rule stored in the storage unit.

3. The information processing apparatus according to claim 2, wherein
the rule stored by the storage unit includes at least one of
a rule according to which a search condition that includes an attribute value having a highest ratio, out of the attribute values of the plurality of data whose selection was accepted by the acceptance unit, is generated as the search condition candidate,
a rule according to which a search condition that includes an attribute value having a ratio greater than or equal to a prescribed value, out of the attribute values of the plurality of data whose selection was accepted by the acceptance unit, is generated as the search condition candidate, and
a rule according to which a search condition that includes a logical sum of a prescribed number of attribute values selected in descending order of ratio, out of the attribute values of the plurality of data whose selection was accepted by the acceptance unit, is generated as the search condition candidate.

4. The information processing apparatus according to claim 2, further comprising a changing unit adapted to change the rule stored in the storage unit according to an instruction from the user.

5. The information processing apparatus according to claim 1, wherein the acceptance unit accepts, as selected data for generating the search condition, data stored in a prescribed folder.

6. The information processing apparatus according to claim 5, wherein the generation unit generates the search condition in response to a number of data stored in the prescribed folder exceeding a predetermined value.

7. The information processing apparatus according to claim 5, wherein the generation unit generates the search condition in response to a predetermined time period elapsing after data is stored in the prescribed folder.

8. The information processing apparatus according to claim 1, further comprising an update unit adapted to update the search condition candidate, according to at least one of a user operation to add data to and a user operation to delete data from data obtained as a search result by the search unit.

9. A control method of an information processing apparatus, comprising the steps of:
accepting a selection of a plurality of data for generating a search condition;
reading out, for each piece of the plurality of data, metadata showing attribute values of the piece of data, from a storage device;
analyzing, for each type of attribute, the attribute values shown by the metadata of the plurality of data, and generating a search condition candidate that includes an attribute value representative of the attribute values of the plurality of data;
selectably presenting the search condition candidate generated in the generation step to a user; and
retrieving, from a plurality of search target data, data that matches a search condition candidate selected by the user.

10. A computer program stored in a computer-readable storage medium for causing a computer to function as an information processing apparatus as claimed in claim 1.

11. A computer-readable storage medium storing a computer program as claimed in claim 10.
